(19) United States
(12) Patent Application Publication
(10) Pub. No.: US 2023/0177227 A1
(43) Pub. Date: Jun. 8, 2023

(54) Model-Order-Reduction Method for Large-Scale Topology Optimization Designs Based on Domain Decomposition and Artificial Neural Networks

(71) Applicant: The Hong Kong University of Science and Technology, Hong Kong (CN)

(72) Inventor: Wenjing YE, Hong Kong (CN)

(21) Appl. No.: 18/057,249

(22) Filed: Nov. 21, 2022

Related U.S. Application Data
(60) Provisional application No. 63/286,566, filed on Dec. 7, 2021.

(51) Int. Cl. G06F 30/17; G06F 30/23; G06F 30/27

(52) U.S. Cl. CPC G06F 30/17; G06F 30/23; G06F 30/27

(57) ABSTRACT

In topology optimization (TO) of a structure, a mechanical field of the structure is required to evaluate the objective function and/or constraints. In a model-order-reduction method for efficiently computing the mechanical field, a fine-scale structure modelling the structure is first coarsened to give a coarse-scale structure. A finite element method (FEM) is applied to the coarse-scale structure to obtain a coarse-scale mechanical field. A fine-scale mechanical field is computed from the coarse-scale one instead of using the FEM to directly compute the fine-scale mechanical field from the fine-scale structure, allowing the fine-scale mechanical field with a higher accuracy than the coarse-scale one to be used as the mechanical field while achieving computation cost saving. In generating the fine-scale mechanical field, an artificial neural network, entitled as MapNet, is used to map the coarse-scale mechanical field to the fine-scale one. The MapNet is realizable with convolutional layers and deconvolutional layers.

### CROSS-REFERENCE TO RELATED APPLICATIONS

This application claims priority to, and the benefit of, U.S. Provisional Patent Application No. 63/286,566 filed on Dec. 7, 2021, the disclosure of which is hereby incorporated by reference in its entirety.

### LIST OF ABBREVIATIONS

2D two-dimensional

3D three-dimensional

ANN artificial neural network

BESO bi-directional evolutionary structural optimization

CNN convolutional neural network

CPU central processing unit

FEM finite element method

MSE mean squared error

NN neural network

PINN physics-informed neural network

RELU rectified linear unit

SIMP solid isotropic material with penalization

TO topology optimization

### TECHNICAL FIELD

The present invention relates generally to TO of large-scale designs. Particularly, the present invention relates to an ANN-based model-order-reduction technique for computing a mechanical field of a structure, and an application to the technique for performing TO of large-scale designs with a substantial reduction of expensive computational cost of numerical evaluation of the objective function and constraints.

### BACKGROUND

Structural design has always been playing an important role in engineering field from the design of industrial products such as aircraft components to the design of advanced materials like metamaterials. One of the common design methods especially in the field of mechanical engineering is TO in which the material distribution is optimized systematically within a prescribed design domain to achieve a design objective while subjecting to certain design constraints. However, due to the repetitive evaluations of the objective function and constraints required during the TO process, which are typically carried out by numerical simulations such as FEM-based analysis, the computational cost of the TO method could be prohibitively large for large-scale designs. For example, the design of airplane foil with giga-hertz resolution may require 8000 CPUs running simultaneously for days.

One of the effective solutions to accelerate the TO process and reduce the computational cost of large-scale designs is to speed up the large-scale simulation. Various methods have been developed over the years, starting with conventional reduced order methods used in early years. With the rapid development of deep learning methods in recent years, deep learning models such as ANN have been adopted in various physical fields. One of the advantages of ANNs is that once constructed, predictions form ANNs can be rapidly computed with the time scale on the order of milliseconds. This advantageous property of ANN has been utilized in large-scale analysis with the ANN serving as the surrogate model to replace time-consuming numerical simulations such as FEM calculations. ANN-based surrogate models have been widely adopted in the field of structural mechanics for the prediction of mechanical responses of structures. This implementation was used in the works, for example, by White et al. (2019), Tan et al. (2019), Lee et al. (2020) and Nie et al. (2020). These works utilized either the fully connected NN or CNN for the prediction of mechanical fields such as stress/strain field of structures subjected to various loadings.

Another approach to speed up the design process is to apply deep learning models to directly predict the optimized or near-optimal structures, partly or completely skipping over the optimization process, which is seen in works by Sosnovik et al. (2019), Yu et al. (2019), Kollmann et al. (2020), and Ates et al. (2021). In these deep learning models, the input is either the intermediate structure generated during the TO process or the initial design, and the output is the optimized structure, essentially treating structure designs as images. Therefore, these models can be used as black-box without requiring any prior knowledge associated with the design problem, and the computational time is reduced by skipping the design process. However, in order to train the model, many TO design solutions must be pre-produced, which in turn requiring a large number of FEM calculations.

Despite the great interest and efforts on the development of machine learning-based efficient TO methods, the existing methods/models suffer from two major shortcomings. The first one is the need for a large set of training data. With the required data mostly generated through time-consuming simulations, such as the FEM, the time required for the generation of training data increases with the problem size. It is impractical for large-scale structural designs. Several methods have been proposed to reduce the number of training data. For example in the work by Qian and Ye (2021), only the designs in early stage of optimization are used as training data. The data from the later stage of optimization are omitted since most of these designs are similar to those in previous iterations and therefore do not contribute much to the learning process of the machine learning model. However, although the number of training data has been reduced, expensive FEM calculations are still required to be performed. It might become a problem for large-scale TO designs, for example, those with giga-scale resolution, as the computational power requirement for the calculations is too high and may not be easily accessible. In another work by Chi et al. (2021) an online updating scheme is proposed to avoid the long offline training, thereby avoiding the need for a large pool of training data. However, since an online training scheme is utilized, the model is required to be trained in real time for every new problem. The efficiency of this method therefore declines if problems with different conditions are required to be solve repeatedly, for example, in compliance minimization design problem with different locations of applied load and volume fraction requirements.

Another drawback in most of the works mentioned above is the poor transferability of the trained models, with their prediction accuracy dropping significantly when applied to “unseen” settings. As a result, most existing models have rather narrow application scopes, difficult to generalize to problems with different settings particularly with different domain shapes and sizes. A main reason for the narrow application scope is that in these models, the machine learning model maps the entire domain, which is represented as an image, and possibly boundary/loading conditions to its corresponding output, for example, the stress field or the design solution. To accommodate for different domains and conditions, a large set of representative training data is required, which is challenging if not impossible to generate for large-scale designs.

One approach to reduce the number of training data and/or improve the transferability is to incorporate the physics into the machine learning process or machine learning models. An example of the former case is the PINN approach, which has attracted great attention recently. In the PINN approach, the physics is embedded in the loss function. As a result, very little or even no training data is needed. The trade-off is that the training time greatly increases because the complexity of the training, which is effectively a multi-objective optimization problem, increases. The latter case can be seen in the work of Wang et al. (2021), in which the neural network maps the mechanical field such as the displacement and/or the stress/strain field of the initial design to the corresponding design solution. The input of the ANN model contains certain physics of the problem. Hence, the model has a relatively strong generalization ability. It can predict design solutions of the same problem with different boundary conditions even though the model was trained on one boundary condition. However, the quality of the produced design solutions needs to be improved and the model seems to be only applicable for a fixed design domain.

There is a need in the art for an ANN-based technique that enables a great reduction of computational cost encountered in expensive numerical evaluation of the objective function and constraints so as to speed up the TO process for large-scale designs.

### SUMMARY

A first aspect of the present invention is to provide a first computer-implemented method for computing a mechanical field of a structure.

In the first method, the structure is discretized using a fine-scale mesh by dividing the structure into a plurality of fine-scale elements. The fine-scale structure is then coarsened to yield a coarse-scale structure such that the coarse-scale structure is composed of a plurality of coarse-scale elements, the first number of respective coarse-scale elements in the plurality of coarse-scale elements being less than a second number of respective fine-scale elements in the plurality of fine-scale elements. A FEM is applied to the coarse-scale structure to calculate a coarse-scale mechanical field of the structure. A fine-scale mechanical field of the structure is then computed from the coarse-scale mechanical field. The computing of the fine-scale mechanical field from the coarse-scale mechanical field comprises: fragmenting the coarse-scale mechanical field into a plurality of fragments, whereby an individual fragment has a fragment boundary on the coarse-scale mechanical field such that the individual fragment is a local portion of the coarse-scale mechanical field within the fragment boundary; using an ANN to map the local portion of the coarse-scale mechanical field to a corresponding local portion of the fine-scale mechanical field, whereby respective local portions of the fine-scale mechanical field for the plurality of fragments are computed; and combining the respective local portions of the fine-scale mechanical field to generate the fine-scale mechanical field. The generated fine-scale mechanical field is set to be the mechanical field of the structure. Thereby it allows the fine-scale mechanical field with a higher accuracy than the coarse-scale mechanical field to be used as the mechanical field without a need to use the FEM to directly compute the entire fine-scale mechanical field from the fine-scale structure for computation cost saving.

The ANN is exemplarily implemented as MapNet.

Preferably, the MapNet comprises plural convolutional layers, plural deconvolutional layers and a residual block. Each of the convolutional and deconvolutional layers has a filter size of 3×3, a stride of 2×2 except for a last layer of the MapNet, and an activation function of RELU. The last layer of the MapNet has a 1×1 stride. The MapNet has one feature that inputs of the MapNet are the local portion of the coarse-scale mechanical field, and a corresponding local portion of a fine-scale density field within the fragment boundary, where the fine-scale density field is defined by the fine-scale structure. In addition, the MapNet has another feature that at each deconvolutional layer, a density field with the same scale downsampled from the fine-scale density field is added. Both features are unique and critical for achieving a high accuracy in computing the corresponding local portion of the fine-scale mechanical field.

In mapping the local portion of the coarse-scale mechanical field to the corresponding local portion of the fine-scale mechanical field, preferably the ANN predicts the corresponding local portion of the fine-scale mechanical field according to a fine-scale density field and the local portion of the coarse-scale mechanical field. The fine-scale structure defines the fine-scale density field.

In coarsening the fine-scale structure to yield the coarse-scale structure, the coarse-scale structure is obtained by scaling down a fine-scale density field to give a coarse-scale density field. The fine-scale structure defines the fine-scale density field, and the coarse-scale density field defines the coarse-scale structure.

In fragmenting the coarse-scale mechanical field into the plurality of fragments, fragment overlapping among respective fragments in the plurality of fragments may be present or absent.

A second aspect of the present invention is to provide a second computer-implemented method for performing TO of a structure according to a design requirement. The design requirement is specified as minimizing or maximizing an objective function subjected to one or more constraints.

The second method comprises the steps of: (a) selecting a candidate structure for testing whether the candidate structure satisfies the design requirement; (b) computing a mechanical field of the candidate structure according to any embodiment of the first method as disclosed herein; (c) using the computed mechanical field to evaluate the objective function, the one or more constraints, or both of the objective function and the one or more constraints; (d) determining whether the candidate structure satisfies the design requirement; and (e) if the candidate structure does not satisfy the design requirement, updating the candidate structure and repeating the steps (b)-(e), otherwise setting the candidate structure that satisfies the design requirement as the structure obtained by TO.

In certain embodiments, the objective function and the one or more constraints are related to a structural compliance minimization design problem. The mechanical field is a strain energy field.

In certain embodiments, the objective function and the one or more constraints are related to a thermal compliance minimization design problem. The mechanical field is a temperature field.

Other aspects of the present disclosure are disclosed as illustrated by the embodiments hereinafter.

### BRIEF DESCRIPTION OF THE DRAWINGS

FIG. 1A illustrates, as illustrative examples, design domains considered in structural compliance minimization design problems for (a) a cantilever beam with a load applied at an upper right corner, (b) a cantilever beam with multiple loads, (c) an L-shaped beam, and (d) a bridge.

FIG. 1B illustrates, as illustrative examples, design domains considered in thermal compliance minimization design problems for two different settings of boundary conditions: (a) a small region of fixed temperature; and (b) a large region of fixed temperature.

FIG. 2 depicts a schematic diagram of a conventional FEM-based TO design framework.

FIG. 3 depicts a schematic diagram of a proposed design framework based on MapNet in accordance with an exemplary embodiment of the present invention.

FIG. 4 depicts a coarsening process for converting a fine-scale structure to a coarse-scale structure in performing TO of a structure.

FIG. 5 depicts a fragmentation process f or cropping the domain into smaller subdomains (fragments) in performing TO of the structure.

FIG. 6 provides a comparison between non-overlapping and overlapping fragmentation processes.

FIG. 7 depicts an illustration showing similar fragments between a cropped L-shaped beam and a cantilever beam structure.

FIG. 8 is a schematic diagram of an exemplary architecture of MapNet.

FIG. 9 depicts an illustration showing the fragmentation, MapNet prediction and defragmentation process, starting from a coarse-scale strain energy field and a fine-scale density field, and finally going to fine-scale strain energy field.

FIG. 10 depicts samples of the distributions of the coarse-scale and fine-scale strain energy fields obtained from the fragments of cantilever beam design problem.

FIG. 11 illustrates prediction of strain energy field (fragments) by MapNet trained with different number of training data (cantilever beam problem).

FIG. 12 provides a comparison of strain energy field (fragments) predicted by MapNet trained with: neither fragmented data nor density field; only fragmented data; and both fragmented data and density field to the ground truth.

FIG. 13 provides a comparison of strain energy fields predicted by MapNet between a first case that MapNet is trained with neither fragmentation nor fine-scale density, and a second case that MapNet is trained with both.

FIG. 14 provides (a) a comparison of strain energy fields predicted by MapNet trained with a fine-scale density under different cropping scales of fragments, and (b) a zoomed-in comparison of the predicted strain energy field from results shown in the first column of the subplot (a).

FIG. 15 provides an illustration showing examples of non-uniqueness issue.

FIG. 16 provides a comparison of strain energy fields predicted by MapNet trained with non-overlapping fragmentation and with overlapping fragmentation.

FIG. 17 provides a comparison of cantilever beam TO results by the conventional FEM method and the disclosed MapNet method.

FIG. 18 provides a comparison of TO results between the FEM-based method and the disclosed MapNet method for a cantilever beam with multiple load applied.

FIG. 19 provides a comparison of TO results between the FEM-based method and the disclosed MapNet method for an L-shaped beam.

FIG. 20 provides a comparison of TO results between the pure FEM-based method and the disclosed MapNet method for a bridge design problem.

FIG. 21 provides a comparison between TO results of the pure FEM-based method and the disclosed MapNet method (SIMP) for a cantilever beam.

FIG. 22 provides a comparison between TO results of the pure FEM-based method and those of the disclosed MapNet method (SIMP) for (a) an L-shaped beam and (b) a bridge design problem.

FIG. 23 provides a comparison between TO results of the pure FEM-based method and those of the disclosed MapNet method for a thermal problem with a small region of fixed temperature.

FIG. 24 provides a comparison between TO results of the pure FEM-based method and those of the disclosed MapNet method for a thermal problem with a large region of fixed temperature.

FIG. 25 depicts a flowchart showing exemplary steps of a first computer-implemented method for computing a mechanical field of a structure as disclosed herein, where a fine-scale mechanical field of the structure is computed from a coarse-scale mechanical field thereof for computation cost saving.

FIG. 26 depicts a flowchart showing exemplary steps in the computation of the fine-scale mechanical field from the coarse-scale mechanical field, where an ANN is utilized in the computation.

FIG. 27 depicts a flowchart showing exemplary steps of a second computer-implemented method for performing TO of a structure according to a design requirement, where the design requirement is specified as minimizing or maximizing an objective function subjected to one or more constraints.

Skilled artisans will appreciate that elements in the figures are illustrated for simplicity and clarity and have not necessarily been depicted to scale.

### DETAILED DESCRIPTION

In the present disclosure, an ANN-based model-order-reduction method is proposed, disclosed and developed for greatly reducing the computational cost of the expensive numerical evaluation of the objective and constraints and thus to speed up the TO process for large-scale designs. In particular, this method is scalable and adaptable to different problem settings including the changing domain size and shape without the need to retrain the deep learning model.

An overview of the disclosed method is first provided as follows. In the method, the objective function and/or constraints are evaluated on a coarser mesh instead of the original mesh using conventional methods such as the FEM. An ANN model, entitled as MapNet, is then used to map the coarse-scale mechanical field to the fine-scale mechanical field. The major benefit of this approach is that the coarse-scale field, which can be obtained cheaply, contains the physical information, such as the boundary and loading conditions. If boundary/loading conditions change, the coarse-scale field changes accordingly. Compared with ANN models that map the structure to its fine-scale mechanical field, training MapNet is easier and requires less fine-scale data because the network only needs to learn the relationship between a coarse mechanical field and its corresponding fine mechanical field. To improve the transferability and scalability, the approach of domain decomposition is utilized in the disclosed method. The problem domain is decomposed into a set of small subdomains or fragments, and the network is constructed to perform the mapping on each small subdomain instead of the entire problem domain. The predicted field of each subdomain is then combined to form the field of the original domain. A major advantage of this approach is that many different domains with varying sizes and shapes can potentially be decomposed into similar sets of subdomains/fragments, the MapNet trained with data from a specific design problem can be more easily transferred to different problems. Besides, the number of training data is increased because one data of the entire domain can be decomposed into many subdomain data, thereby increasing the accuracy of the network.

The disclosed method is hereinafter illustrated by first describing exemplary design problems used for demonstrating the performance of the disclosed method. The detailed implementation of the disclosed method is discussed next. The accuracy and efficiency of the method is then demonstrated on various design problems having different design domains and boundary conditions, benchmarked with results obtained from the conventional TO method. Finally, various embodiments of the present invention are developed and detailed.

### A. Problem Statement

The development of the disclosed ANN-based model-order-reduction method is demonstrated on two benchmark design problems of TO methods, specifically the structural and thermal compliance minimization design problems.

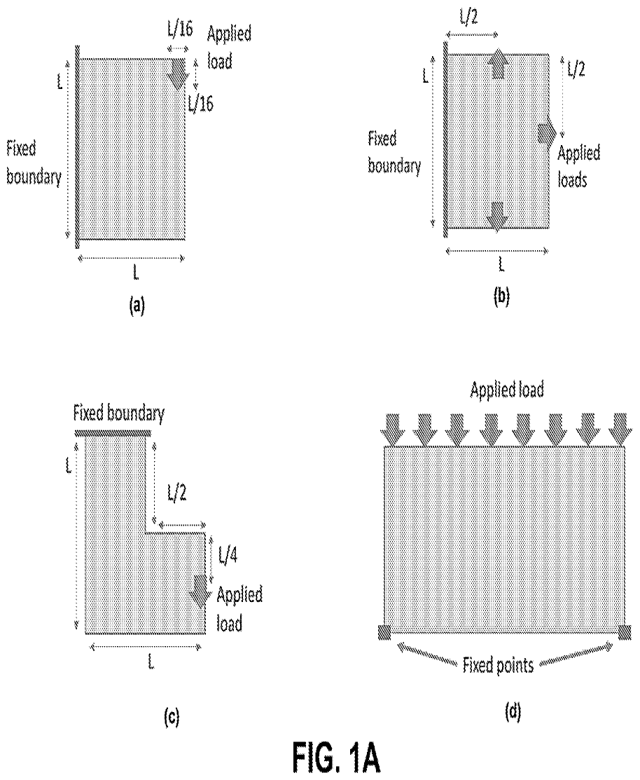

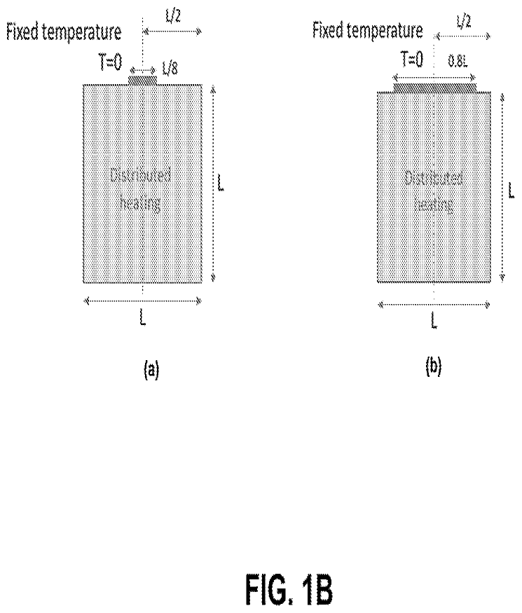

The structural compliance minimization design problem can be expressed mathematically in a discretized form as

$${min}_{x} : C ( x ) = {U}^{T} K U = {\sum }_{i = i}^{n} {E}_{i} ( {x}_{i} ) {u}_{i}^{T} {k}_{0} {u}_{i} subjected to : \frac{V ( x )}{{V}_{0}} = f KU = F \qquad ( 1 )$$

where: x, which is the design variable, is the elementwise “density”; C(x) is the objective function; U is the displacement vector; K is the global stiffness matrix; F is the loading vector; uᵢ is the displacement vector of the ith element; k₀ is the local stiffness matrix associated with the element occupied with solid material; V(x) represents the volume of the structure and V₀ is the volume of the entire design domain; f is the desired volume fraction. As an illustrative example used in demonstrating the disclosed method, the volume fraction constraint is set as 0.4 for all cases. Also, for demonstrating the disclosed ANN-based model-order-reduction method, two common TO methods, the BESO and the SIMP, are used to perform TO designs. The elementwise density x is either 0 or 1 in BESO, and is a value between 0 and 1 in SIMP with 0 representing the void and 1 representing the solid phase of the structure, respectively. The design objective is to optimize the topology, that is, the density, of structures within the design domain, so that the compliance (strain energy) of the structure is minimal while subjecting to a given loading and volume fraction. A variety of design cases with different domains, boundary and loading conditions are selected to demonstrate the transferability of our method, starting with the classical 2D cantilever beam design as illustrated in subplot (a) of FIG. 1A. The design domain is a square with the left boundary being fixed and a vertical distributed load applied at the upper right boundary of the domain. The second design problem is the same as the cantilever design except that instead of one single load, three distributed forces are applied at the centers of the top, the center of right and the center of bottom boundaries respectively as illustrated in subplot (b) of FIG. 1A. Two more design cases, that is, the L-shaped beam and the bridge designs respectively shown in subplots (c) and (d) of FIG. 1A, are also considered. The two cases have distinct domain shapes and sizes. In addition, boundary and loading conditions are entirely different from those of cantilever design problems. For the beam design of (a), (b) and (c), the distributed load is applied on a square region of L/16 by L/16, while for the bridge design problem the load is distributed over the whole top boundary.

In order to demonstrate the versatility of the disclosed ANN-based model-order-reduction method, the thermal compliance minimization design problem is also solved using the disclosed method. In this problem, the design objective is to minimize thermal compliance subject to given thermal loading and boundary conditions. The mathematical model of the design problem is given by

$${min}_{x} : C ( x ) = {T}^{T} {K}_{c} T subjected to : \frac{V ( x )}{{V}_{0}} = f {K}_{c} T = F 0 \leq x \leq 1 \qquad ( 2 )$$

where: x, which is the design variable, is the elementwise “density”; C(x) is the objective function; T is the temperature field; K_{C} is the conductivity matrix; and F is the thermal loading including contributions from boundary heat flux and internal heat generation/loss. The SIMP method is used for this problem and the design domain is a square. The design problem is based on the one demonstrated in the works of M. BENDSOE and O. SIGMUND (2003) and X. QU, N. PAGALDIPTI, R. FLEURY and J. SAIKI (2016), in which the design domain is isolated at all edges except for the heat sink located across the center of the top boundary. The plate is subjected to distributed heating all over the plate. Two different boundary conditions are considered, with the first one having a smaller region of fixed temperature and the second one having a larger region. The length of the boundary having the fixed temperature is illustrated in FIG. 1B.

### B. Methodology

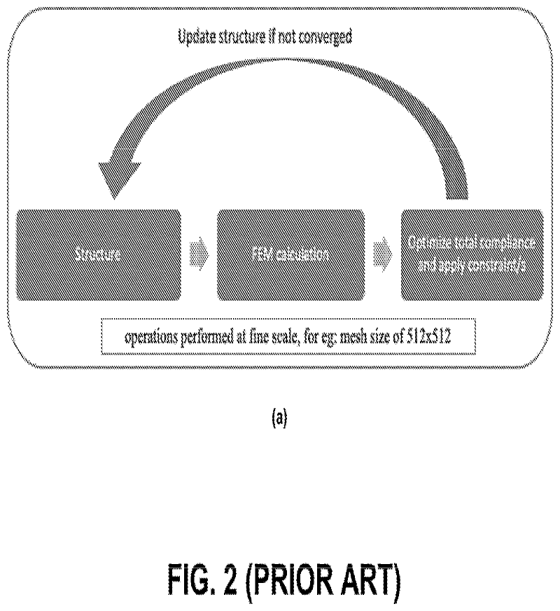

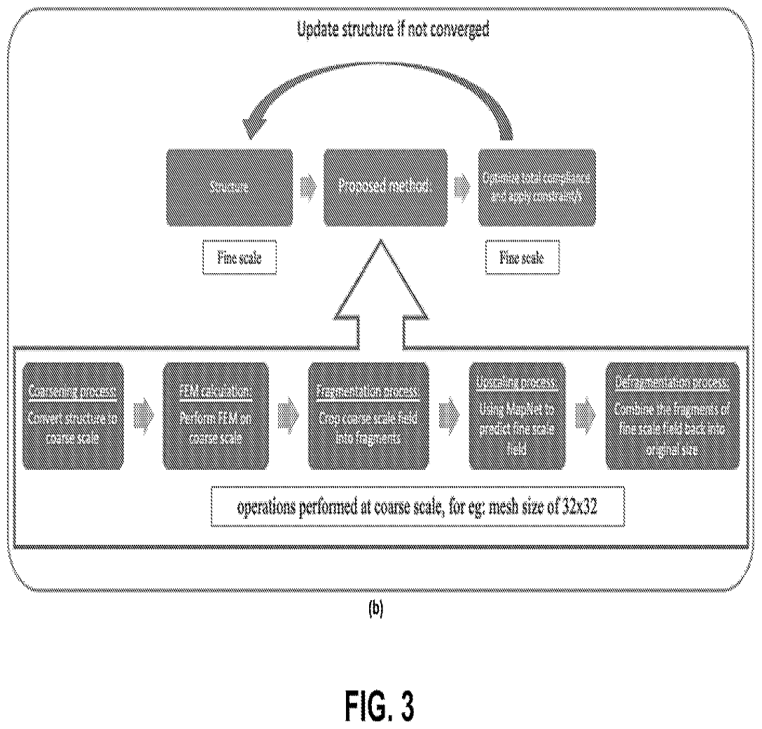

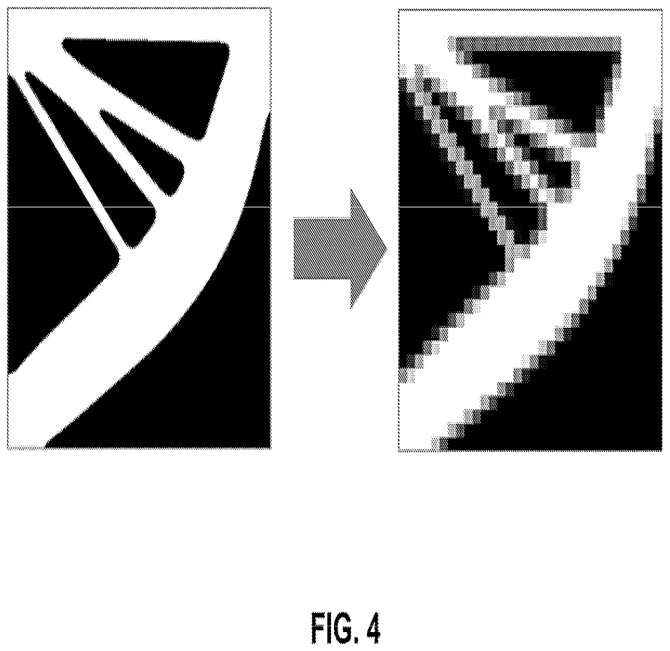

As mentioned above, in the disclosed ANN-based model-order-reduction method, the evaluation of the objective function and/or the constraint(s) in each TO iteration is conducted using MapNet instead of the numerical simulation used in conventional TO methods. The main process of the evaluation can be separated into five steps. First, the fine-scale structure is scaled down to its coarse-scale structure (coarsening) and the FEM calculation is performed at the coarse scale to obtain the field needed for the evaluation of the objective function and/or constraints. Next, the entire domain/field is decomposed into a set of smaller fragments (fragmentation). MapNet is then used to map the coarse-scale field of each fragment to the corresponding fine-scale field. At last, the fragments of the fine-scale field are combined to form the fine-scale field of the original domain (defragmentation). The process is illustrated in the flowchart of FIG. 3 with comparison to the conventional FEM-based TO as shown in FIG. 2. Detailed description of each part is presented in the following paragraphs.

Coarsening is performed by scaling down the fine-scale density field of the structure with N_{F} number of elements to its coarse-scale density field with N_{C} number of elements, where N_{C} should be much smaller than N_{F} to achieve high efficiency. The density value of a coarse-scale element is obtained by averaging the density values of N_{F}/N_{C} fine-scale elements. FIG. 4 shows one sample of the conversion from a fine-scale structure to a coarse-scale structure. In the second step, FEM calculation is performed on the coarse-scale structure to obtain its physical field such as stress/strain field. Since the scale difference is large between the coarse and fine scales, the reduction in simulation time can be significant.

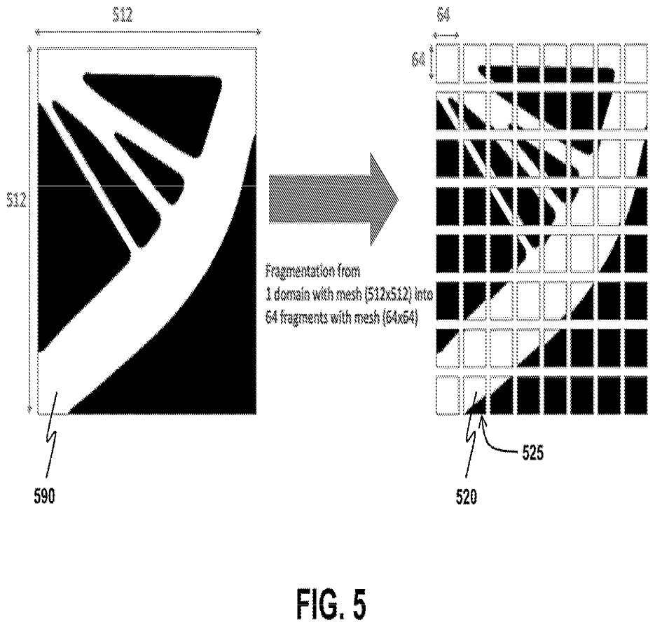

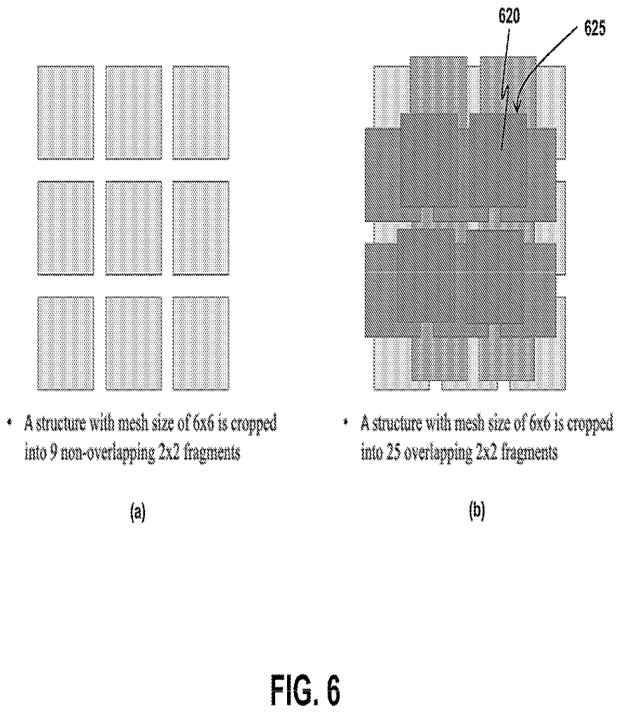

Next, fragmentation is performed on the entire field as illustrated in FIG. 5. Using one sample of the density field obtained from the cantilever design problem as an example, the fine-scale structure is cropped into 64 smaller non-overlapping fragments. But instead of the non-overlapping cropping, one can go a step further by introducing overlapping cropping as shown in FIG. 6. In fact, overlapping cropping is more advantageous because when the fragments are combined to form the entire field, there are less likely for discontinuities to occur at the edge of each fragment, thus making the overall field smoother.

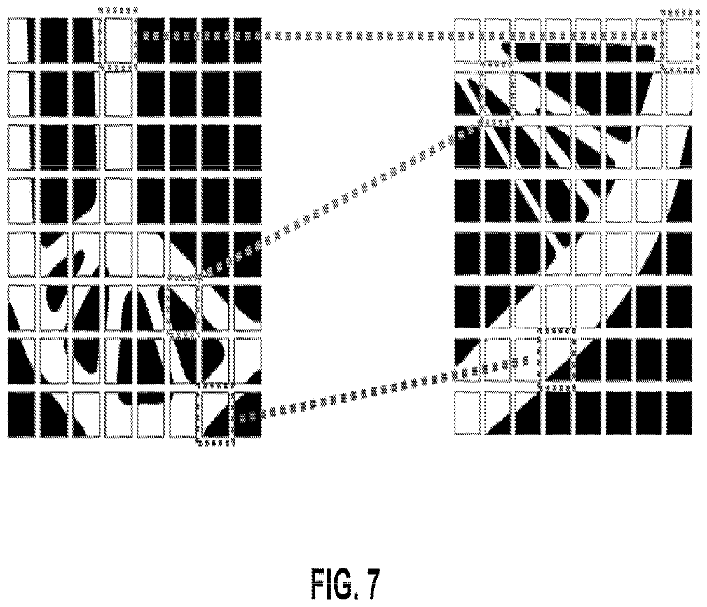

As mentioned previously, using MapNet to map the field of a fragment instead of the whole domain helps improving the transferability. It is because fragments of different designs are more likely to resemble to each other even through the overall designs are entirely different. Considering the comparison between the cantilever beam and the L-shaped beam shown in FIG. 7, it is not difficult to see that they are very different in view of the entire structure. However, as the domain is cropped into fragments, there are now more similar fragments as indicated by the connecting indicator in FIG. 7. Therefore, if the MapNet is trained with the cropped cantilever beam data, it likely can provide accurate predictions for L-shaped beam without any retraining. The advantage is even more apparent in design cases with different domain sizes and shapes. Besides, the fragmentation process can also increase the number of training data for MapNet. For example, as demonstrated in FIG. 5, one sample of structure has been cropped into 64 samples after the fragmentation, providing 64 times more samples that can be used to train MapNet. It should be pointed out that the fragmentation method is only possible with the special way MapNet is constructed. Since MapNet predicts the fine-scale field from the coarse-scale field, it does not need additional inputs about the external constraints on the problem, such as boundary conditions or loading conditions. However, if the ANN is built to map the density field of the structure to the corresponding mechanical field, fragmentation could not be performed because additional inputs on boundary/loading conditions are required.

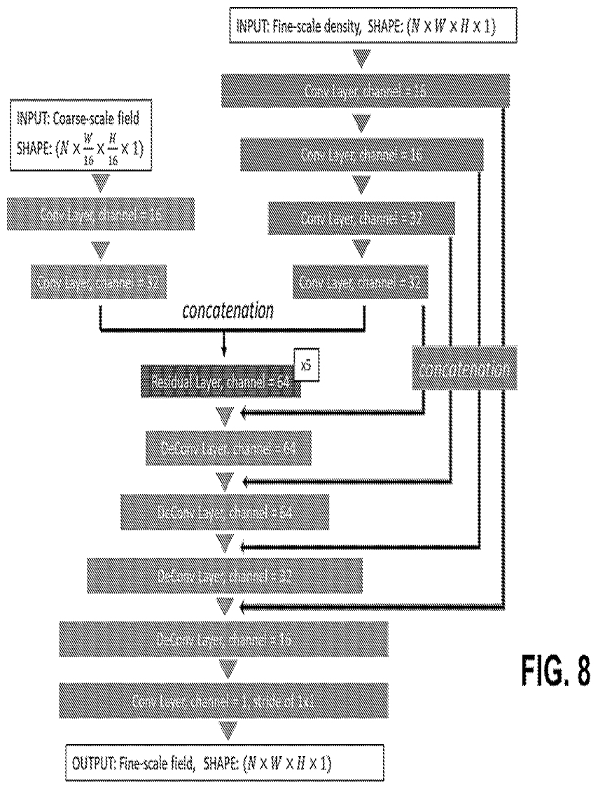

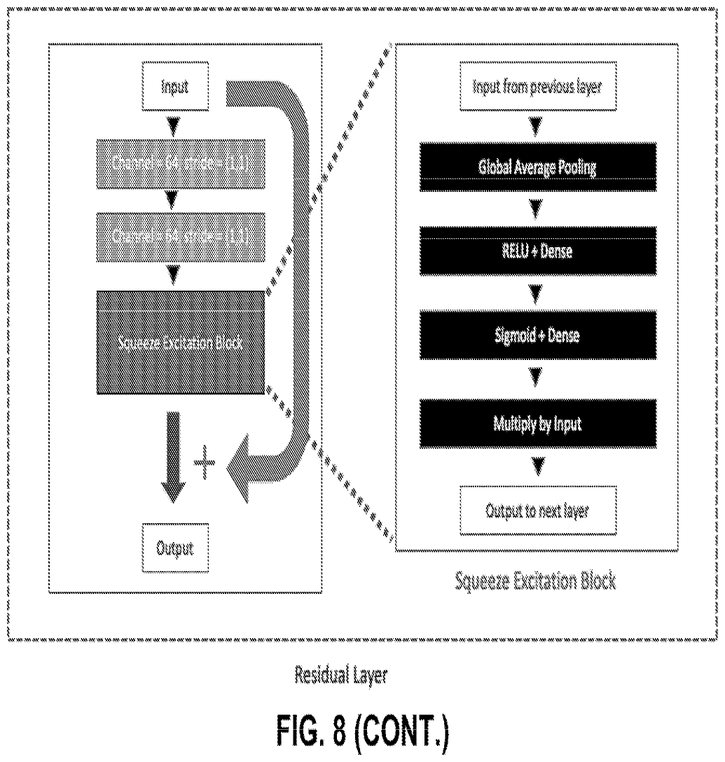

After fragmentation, MapNet is used to map the coarse-scale field of each fragment to its fine-scale field. The architecture of MapNet is illustrated in FIG. 8, with each of convolutional and deconvolutional layers having a filter size of 3×3, a stride of 2×2 (except for last layer with 1×1 stride), and an activation function of RELU. MapNet has one feature that inputs of MapNet are a local portion of the coarse-scale mechanical field within a boundary of a fragment, and a corresponding local portion of a fine-scale density field within the same fragment boundary, where the fine-scale density field is defined by the fine-scale structure. In addition, MapNet has another feature that at each deconvolutional layer, a density field with the same scale downsampled from the fine-scale density field is added. Both features are unique and critical for achieving a high accuracy in computing the corresponding local portion of the fine-scale mechanical field. Details of the architecture of MapNet can be found in the code for MapNet at Github repository. The coarse-scale mesh size illustrated in the architecture of MapNet is chosen as 1/16th of the fine-scale mesh size in both width and height. In order to facilitate the training of MapNet, the data used as the input and output are all represented in 2D array, with each element in the array representing the field value at the corresponding location for the 2D design problem. However, due to the convolution-based architecture of MapNet, the dataset having N number of samples is reshaped into (N×W×H×1), where W and H represent the width and the height of each array, respectively. The Inventors have found through experimentation that by applying the concept of U-Net into MapNet, the performance can be improved. In addition, including the fine-scale structure at different deconvolutional layers also helps improving the prediction accuracy.

To train MapNet, one can use the results obtained from early iterations of one FEM-based TO design. Specifically, a conventional FEM-based TO for the cantilever beam design problem described in the subplot (a) of FIG. 1A is conducted. The fine-scale strain energy field and density field during each iteration are extracted to form the training dataset. Results from early iterations of TO are used as training data due to the reason that the topology or the density field of structure undergone major changes only during early iterations, while late iterations involve local fine tuning. The trained MapNet is then applied in other design problems. The fragments of fine-scale strain energy field predicted by MapNet are recombined back to the original scale through a defragmentation process. For the non-overlapping defragmentation, the defragmentation process is straightforward by just combining the prediction edge-to-edge. For the overlapping case, each fragment is also combined with neighboring fragments but average values are taken at each overlapping area on which multiple fragments are overlapped.

### C. Results and Discussions

The performance of MapNet is first analysed. It is followed by the performance of the disclosed method on several common 2D design problems of TO.

C.1. Performance Evaluation of MapNet

The cantilever beam design problem with a volume fraction constraint of 0.4 and a distributed area load applied at the upper right corner as shown in the subplot (a) of FIG. 1 is used to study the accuracy of the MapNet. A design resolution of N_{F}=512×512 is chosen as the fine-scale mesh, while the coarse-scale mesh is chosen to be N_{C}=32×32. The conventional FEM-based TO is ran to produce the design solution, which converges within 200 iterations. The detail values used for each parameter of FEM and TO algorithm could be found in the code available at Github repository. The data obtained from this TO process is used to train MapNet following the procedure discussed in the previous section. First, the effect of the number of training data on the accuracy of the network is analysed. The performance of the MapNet is also compared to that without fragmentation and without embedding the fine-scale density in the network to demonstrate the effectiveness of the disclosed method. Next, the fragmentation method is further analysed by investigating the effect of different fragment sizes on the performance. Lastly, the overlapping technique is discussed and used in fragmentation process.

C.1.1. Number of Training Data

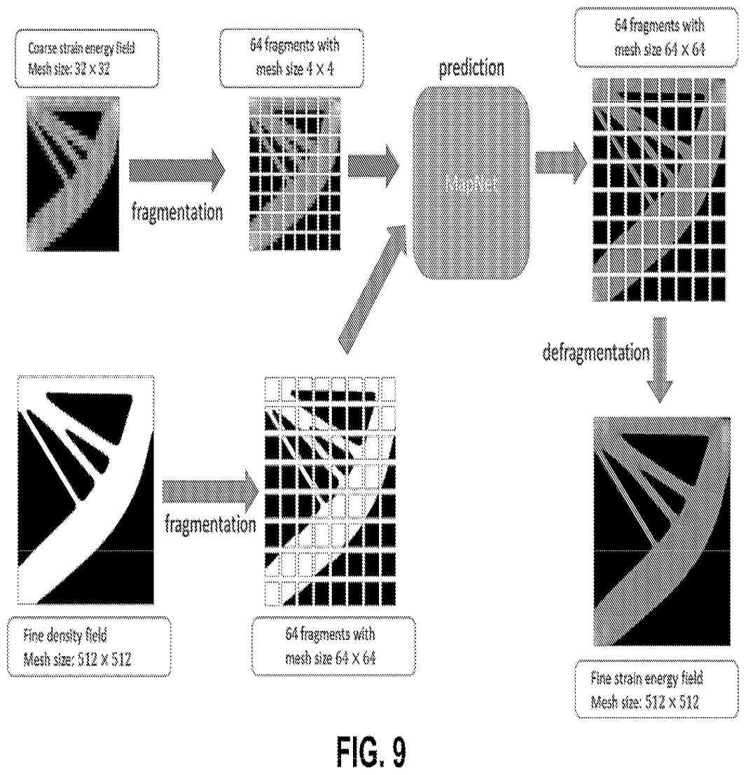

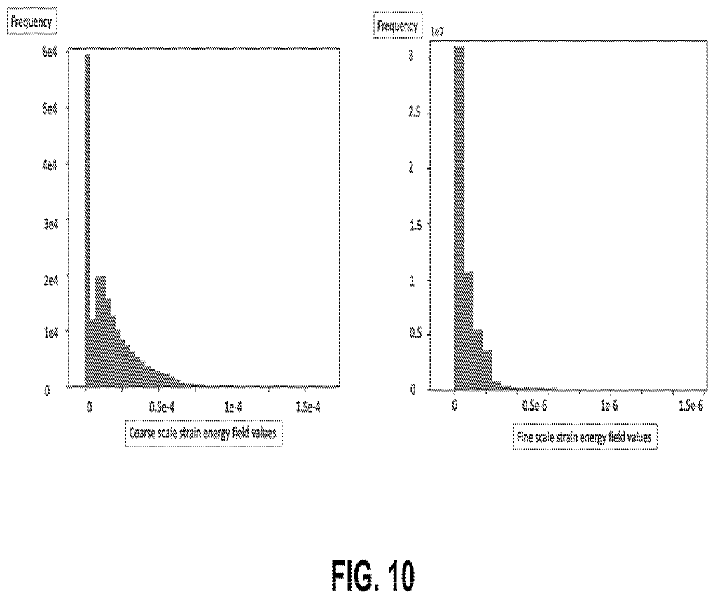

Three sets of fine-scale data with the total number of N=40, 60 and 100 are obtained by running the TO process of the cantilever beam design for N iterations. For example, if the network is to be trained with 40 data, TO is only ran up to 40 iterations. The coarse-scale strain energy field required for the training of the MapNet is obtained by performing FEM on the coarse-scale structure down scaled from the fine-scale structure following the method described above. The strain energy field is then cropped to small non-overlapping fragments using a cropping scale of 16, with each sample of the coarse-scale strain energy field is cropped from the original size of 32×32 to 256 samples of 2×2 fragments. The fine-scale density field and strain energy field are also cropped from their original size of 512×512 into 256 samples of 32×32 non-overlapping fragments. Hence the actual numbers of training data for the MapNet are Nₜᵣₐᵢₙ=256×40, 256×60 and 256×100. The cropping process is shown in FIG. 9. For better visualization, a cropping scale of 8 is used in FIG. 9. Using these cropped data, MapNet is trained using ADAM optimizer and a learning rate of 1e-4. Due to the limitation of computational power, the number of iterations is set to be 1000 steps. In order to ease the training process for the neural network, the values of the input and output are normalized to around the range of 0 to 1. The normalization factors for the coarse and fine scale strain energy fields are selected as 1e-4 and 1e-6, respectively, which are obtained from their distributions shown in FIG. 10.

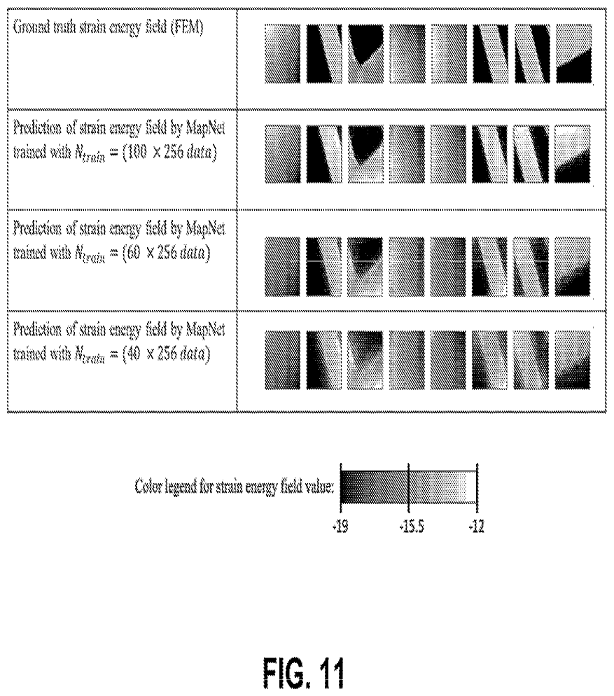

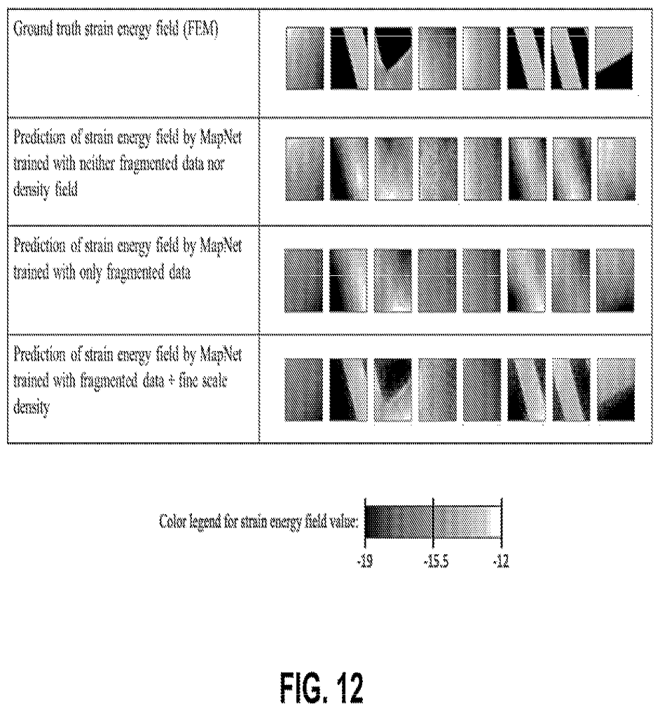

After MapNet is trained, 100 data not including in the training dataset is used to evaluate the accuracy of MapNet. In this case, the data from the 100th to 200th iterations of the conventional FEM-based TO process are selected to be the testing data. Each data is cropped into 256 fragmented data. The fine-scale strain energy field predicted by MapNet on each fragment is compared to that obtained through FEM (ground truth) directly obtained from the FEM-based TO and is shown in FIG. 11. For clear visualization, the strain energy field is plotted in the logarithm scale with an offset of 1e-8, that is, Uₚₗₒₜ=log(U_{original}+10⁻⁸). To provide a qualitative error measure, the MSE is calculated and listed in Table 1. The MSE is defined as

$$\frac{1}{N} {\sum }_{i = 1}^{N} {( {U}_{i}^{N N} - {U}_{i}^{F E M} )}^{2} ,$$

where N is the total number of testing fragments, and Uᵢ^{NN} and Uᵢ^{FEM} refer to the strain energy of the ith element predicted by MapNet and the FEM, respectively. From FIG. 11 and Table 1, it can be observed that as the number of training data increases, the MSE decreased and therefore accuracy of MapNet improves as expected. Based on the consideration of both accuracy and efficiency, MapNet trained with data obtained from 60 TO iterations is selected and used in all the analyses presented in the present work. To demonstrate the effect of fragmentation and the inclusion of fine-scale density field in the ANN, the predicted fine-scale strain energy fields of fragments are also compared to those obtained from MapNet trained without fragmentation, that is, MapNet maps the coarse-scale field of 32×32 directly to the fine-scale field of 512×512, and to those obtained from MapNet constructed without inclusion of the fine-scale density field. Results are presented in FIG. 12. From the comparison, it is obvious that fragmentation and inclusion of the fine-scale density greatly improves the prediction accuracy. In particular, adding the fine-scale density field produces results with much sharper and clearer edges. It is because the fine-scale density field contains information on the general shape of the structure and can provide a filtering effect on the predictions.

TABLE 1
Comparison of MSE achieved by MapNet trained
with different numbers of training data.

| | Number of training data | | |
|---|---|---|---|
| | 100 | 60 | 40 |
| MSE | 0.00029 | 0.00058 | 0.00072 |

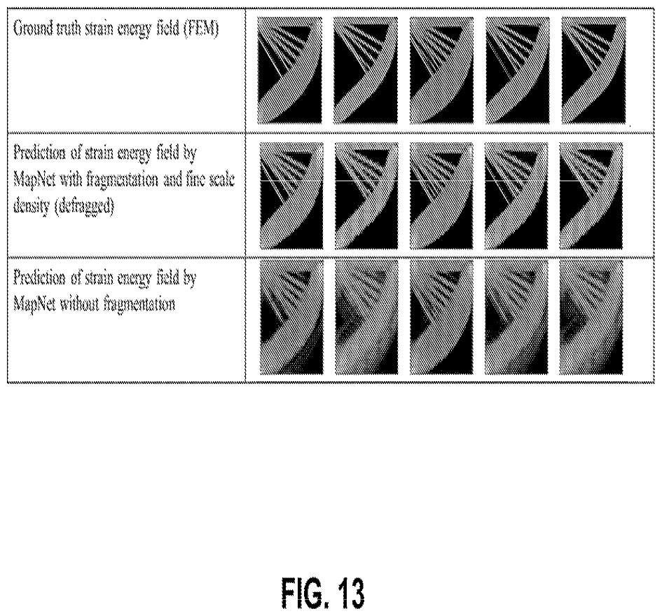

To study the performance of MapNet, it is also important to examine the prediction accuracy of the entire field, that is, the field with its original size of 512×512 obtained after combining all fragmented fields with size of 32×32. This process, which is called defragmentation, is also illustrated in FIG. 9. The defragged strain energy field predicted by MapNet trained with fragmented data and fine scale density is shown in the second row of FIG. 13. Aside from visual comparison, a quantitative comparison is made by calculating the MSE of the prediction, which is tabulated in Table 2. The predictions by MapNet without fragmentation and the density field is also shown in FIG. 13 and Table 1 for comparison. It can be observed that the predicted fine-scale strain energy field with the disclosed method is also much better in the defragged form.

TABLE 2
Comparison of MSE between the network trained
with neither fragmentation nor fine-scale
density, and that trained with both.

| | Trained without | |
|---|---|---|
| | fragmentation and without | Trained with fragmentation |
| MapNet | fine-scale density | and fine-scale density |
| MSE | 0.0017 | 0.0006 |

C.1.2. Fragmentation—Cropping Scale

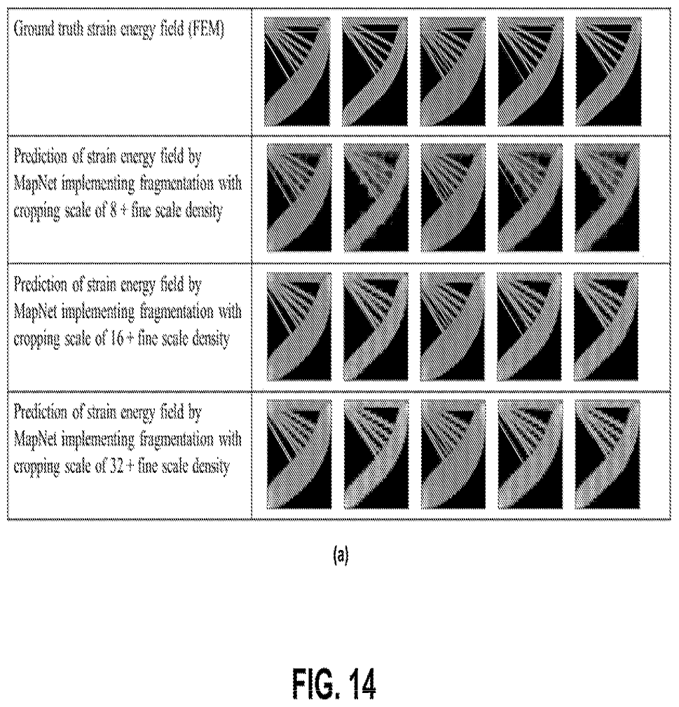

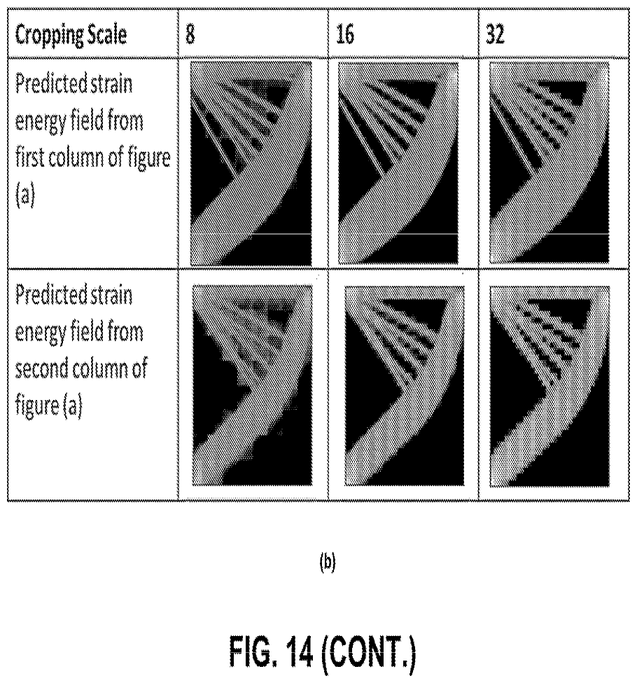

Results shown in the previous section indicate that fragmentation improves the prediction accuracy of the neural network. In these results, a cropping scale of 16 was used for the fragmentation, which has increased the training data by 256 times. If a larger cropping scale is used, for example with a scale of 32, the number of training data can be further increased, and consequently, the accuracy of MapNet would be further improved. However, our study indicates that this is not necessarily the case. The investigation is performed by training MapNet with three different cropping scales of 8, 16 and 32 respectively. Results in the defragged form are compared in FIG. 14 along with the prediction error listed in Table 3 for all the cases.

TABLE 3
Comparison of MSE for MapNet trained with
different cropping scales of fragments

| | Cropping scale | | |
|---|---|---|---|
| | 8 | 16 | 32 |
| MSE | 0.00088 | 0.00058 | 0.00152 |

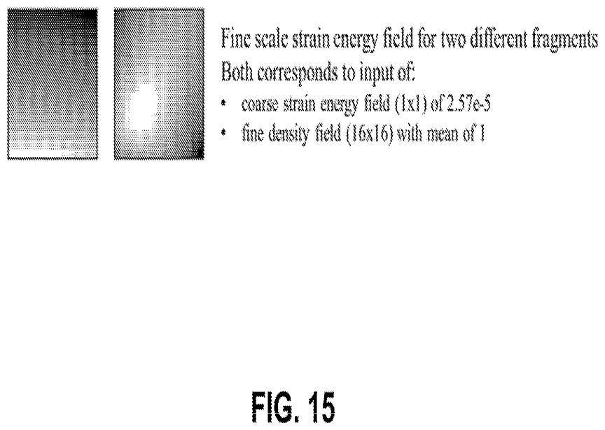

By comparing the results obtained from the cropping scale of 8 with that of 16, it can be observed that the MSE of MapNet decreases with the cropping scale. It is due to the previous explanation that as the cropping scale increases, more fragments are produced, thus increasing the number of training data for training MapNet. However, as the scale increases to 32, which corresponds to a fragment size of 1×1 for the coarse-scale data, and 16×16 for the fine-scale data, the performance dropped with a higher error rate. One reason of this performance drop is that the boundaries between adjacent fragments are not smooth as can be observed in subplot (b) of FIG. 14. Since the fine-scale strain energy of the entire field is obtained by simple recombination of all non-overlapping fragments, it is expected that the values at edges of fragments might not be continuous across adjacent fragments. Another reason might be that as the samples get cropped into smaller fragments, the possibility for non-uniqueness to occur increases. Non-uniqueness refers to the case where the same input for the network corresponds to different output values, essentially having a one-to-many mapping, which makes the training of the network more difficult. For example, as shown in FIG. 10, the coarse-scale strain energy ranges from 0 to 1.5e-4. Therefore, any two values having a difference smaller than 1e-12 are regarded as being identical. By using this criterion and considering the fragmented data for the cropping scale of 32 with a fragment size of 1×1, it has been found that two fragments with the same coarse-scale strain energy value of 2.57e-5 and the exactly identical density field, have two different fine-scale strain energy fields as illustrated in FIG. 15. Therefore, considering the trade-off, the cropping scale should be too large so that non-uniqueness issue could be avoided during the training of MapNet. In this case, the best cropping scale is 16.

C.1.3. Fragmentation—Overlapping Fragmentation

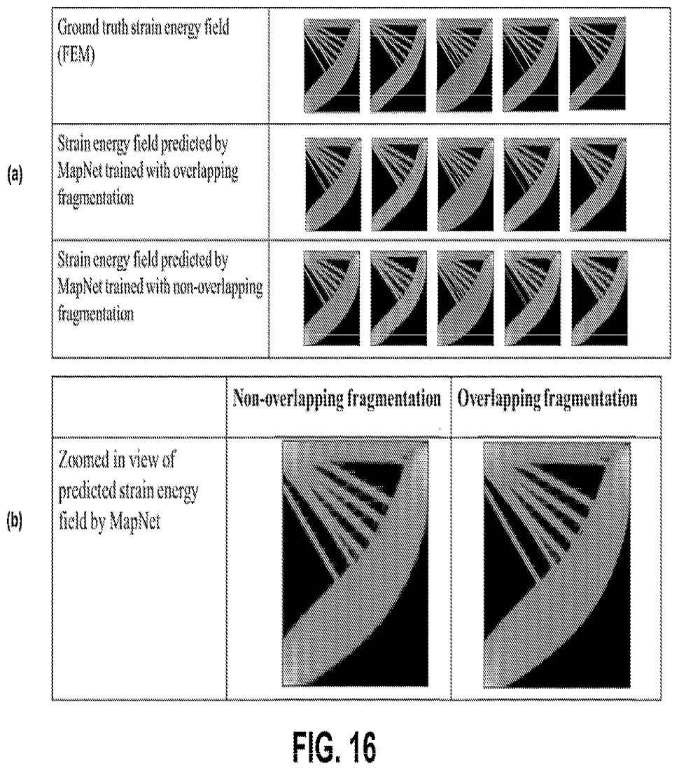

Although the results obtained by fragmentation are already much better than those obtained without fragmentation, by careful observation it can be found that the predicted fine-scale strain energy field in the defragged form are not very smooth at the boundaries of two fragments due to the reason explained in the previous section. In order to overcome this issue, the overlapping method described in Section B (FIG. 6) is utilized. Referring to FIG. 15, overlapping is performed during fragmentation by cropping the domain at a smaller interval. Considering the original domain of 32×32, with a cropping scale of 16, the domain is cropped at each interval of 2 elements. With overlapping, the domain is instead cropped at each interval of 1 element. Therefore, a side length of 32 elements will be cropped into 31 fragments instead of the previous 16. Similarly, after the fragments of fine scale strain energy are predicted by MapNet, the fragments are also combined at interval of 16 elements, with average values taken at any overlapping parts. The results obtained with overlapping fragments are shown in FIG. 16 with the MSE tabulated in Table 4. By comparing the previous result with non-overlapping fragmentation as shown in the same figure and table, the predicted fine-scale strain energy field is observed to be smoother and the error of the MapNet has also decreased further with the utilization of overlapping fragments.

TABLE 4
Comparison of MSE between MapNet trained with
overlapping fragmentation and the one trained
with non-overlapping fragmentation.

Number of Training Data (Nₜᵣₐᵢₙ)

| | Overlapping | Non-overlapping |
|---|---|---|
| | fragmentation | fragmentation |
| MSE | 0.0004 | 0.0006 |

C.2. Application of the MapNet to TO Design

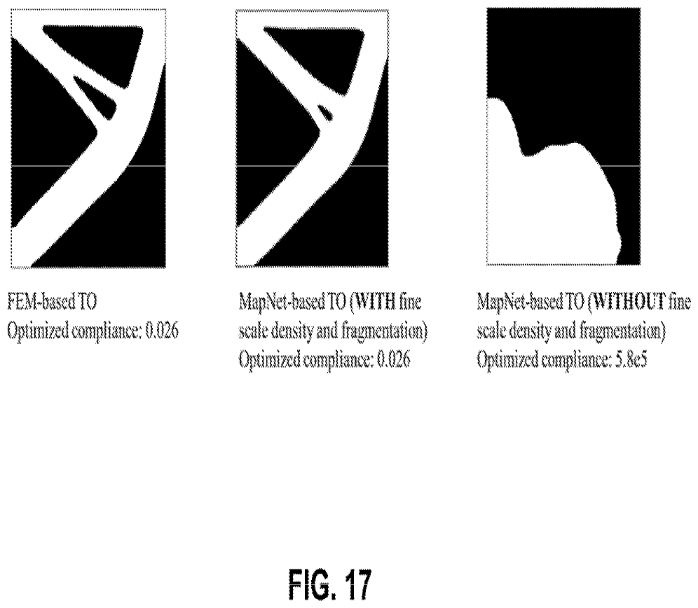

With the MapNet developed and trained using the method discussed in the previous paragraph, it is then implemented into the TO process and the TO process for the cantilever design with a single load illustrated in subplot (a) of FIG. 1 is carried out following the process introduced in the methodology section (flowchart in FIG. 3). In this case, BESO algorithm is used. For clarity, it should be pointed out that MapNet used in all structure designs presented herein is trained with only 60 TO data obtained from the first 60 TO iterations of the cantilever beam design shown in subplot (a) of FIG. 1, and with a cropping scale of 16 and using overlapping fragmentation. The optimized structure obtained from this modified TO process, that is, the MapNet-TO process, is compared to that obtained from the conventional FEM-based TO process in FIG. 17. The final objective, that is, the compliance associated with both structures are also provided in FIG. 17. In addition, the optimized structure obtained from MapNet constructed without fragmentation and fine-scale density field is also shown to demonstrate the superiority of the current MapNet architecture. From the comparison, the first thing to note is that the result from MapNet implementing fragmentation is obviously much better than that without. At the same time, the optimized structure obtained with the MapNet-TO is very similar to that obtained using the conventional method. In the MapNet-TO method, only the coarse-scale field needs to be calculated with the FEM, so that the total computational time required to complete the whole TO process can be greatly reduced. Table 5 shows the detailed breakdown of the time for the relevant phases in each case and the total time required for each iteration in the TO process. The computational time shown is based on the calculation performed on Intel® Xeon® CPU E5-2687Wv2 (3.40 GHz) containing 16 cores. From the table, it can be observed that a 300-times reduction in the computational time is achieved with the MapNet-TO in one single TO iteration. Considering the fact that the TO design in this cantilever beam case requires 200 iterations to converge and only the first 60 iterations are used to generate the training data, the total time saving for completing even one TO process is significant.

TABLE 5
Time comparison for completion of a single TO iteration
by pure FEM-based method and the proposed MapNet method.

| | FEM-TO | MapNet-TO |
|---|---|---|
| Time category | process | process |
| FEM calculation time (s) | ~600 (Mesh | ~0.13 (Mesh |
| | 512 × 512) | 32 × 32) |
| MapNet calculation time + | 0 | 0.92 |
| fragmentation and | | |
| defragmentation time (s) | | |
| The time for the rest of | ~1 | ~1 |
| optimization process (s) | | |
| Total time for each | ~600 | ~2 |
| iteration (s) | | |

C.3. Transferability of the MapNet

In this section, the transferability of MapNet is demonstrated on several benchmark design problems that are different from the cantilever design case used to train MapNet. They are the cantilever beam design with multiple forces, the L-shaped beam design as well as the bridge design problem illustrated in FIG. 1A. Specifically, MapNet trained using the previous simple cantilever design is directly implemented into the TO process to solve the three new design problems without any re-training.

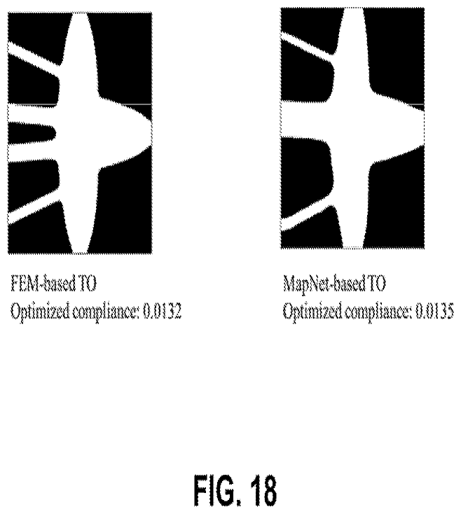

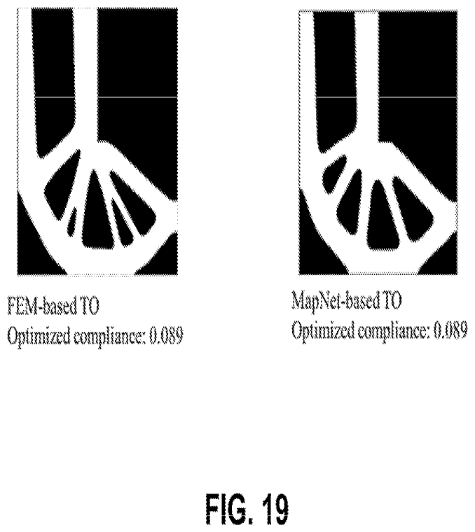

The first two design problems shown in the subplot (a) and (b) in FIG. 1A have the same square design domains with the fine-scale mesh of 512×512 and the coarse-scale mesh of 32×32. BESO algorithm is used as the TO method for all three design cases. The optimized structures and their final compliances obtained through the conventional FEM-based TO and the MapNet-based TO are shown in FIGS. 18 and 19, respectively. As indicated by the results, the optimized structures obtained using the MapNet-TO method resemble those from the FEM-TO method, along with similar final compliances.

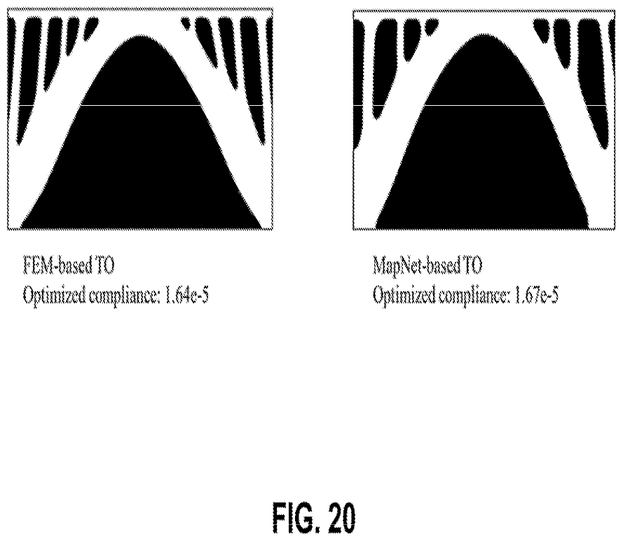

The bridge design problem illustrated in subplot (d) of FIG. 1A has a very different boundary condition and domain shape and size from all other design cases considered. The design domain is discretized into 768(width)×384(height) elements. Design results obtained from the FEM-based TO are shown in FIG. 20. In this case, the coarse-scale mesh is chosen to be N_{c}=48×24. During the fragmentation process, each sample of the coarse-scale strain energy field is cropped into 47×23 fragments of 2×2 with overlapping cropping of 1 element. The fine-scale density field is cropped into 47×23 different fragments of size 32×32. These inputs are then fed to the MapNet to predict the fine-scale strain energy fields of all 47×23 fragments with a size of 32×32. These fine-scale strain energy fields are then combined to form the entire field of the original domain, that is, with the size of 768×384, and the TO process is proceeded as previously discussed. Although the design domain of the bridge is entirely different from that of the cantilever, by using the fragmentation process, the previously trained MapNet can still be directly applied to this problem because it provides the prediction on the fragments/building blocks of the structure instead of the whole structure. Therefore, its generalization capability is much increased. The optimized results obtained from the MapNet-based TO process are also included in FIG. 20. From the results, the MapNet trained with the cantilever beam data again shows excellent performance with the optimized structure and its compliance being very close to that of the ground-truth results.

It should be pointed out that the strain energy field needs to be properly normalized before feeding it into MapNet, otherwise the predicted fine-scale strain energy field would have a large error. Since the ranges of the strain energy of different problems can be different, different normalization factors should be determined and used for different problems. It can be done by observing the coarse and fine-scale strain energy fields from the first several iterations, for example, five iterations of the FEM-based TO process. In the first two design cases, the normalization factor is the same as the simple cantilever design with a single load. In the bridge case, it is found that the normalization factors should be set as 1e-7 and 1e-9 for the coarse and fine-scale data, respectively.

To examine the efficiency, the computational times required to perform the MapNet-based TO in the three new design problems are calculated. For the cantilever beam with multiple applied loads and the L-shaped beam, the time saving per design iteration is similar to that tabulated in Table 4 because they have the same mesh size with the previous cantilever beam problem (512×512). The time saving per iteration for the bridge design problem is slightly different, which is around 250 times as shown in Table 6.

TABLE 6
Comparison of computational time for single iteration
of TO between the pure FEM method and the disclosed
MapNet method for bridge design problem.

| | TO process with | |
|---|---|---|
| | pure FEM | TO process with |
| | calculations on | MapNet |
| Time category | fine scale | implementation |
| FEM calculation time (s) | ~750 (Mesh | ~0.17 (Mesh |
| | 768 × 384) | 48 × 24) |
| MapNet calculation time + | 0 | ~2 |
| fragmentation and | | |
| defragmentation time (s) | | |
| The time for the rest of | ~1 | ~1 |
| optimization process (s) | | |
| Total time for each | ~750 | ~3 |
| iteration (s) | | |
| Total time taken for whole | 1.5 × 10⁵ | 6 × 10² |
| TO process (assuming 200 | | |
| iterations for convergence) | | |

C.4. Applications of the MapNet with SIMP

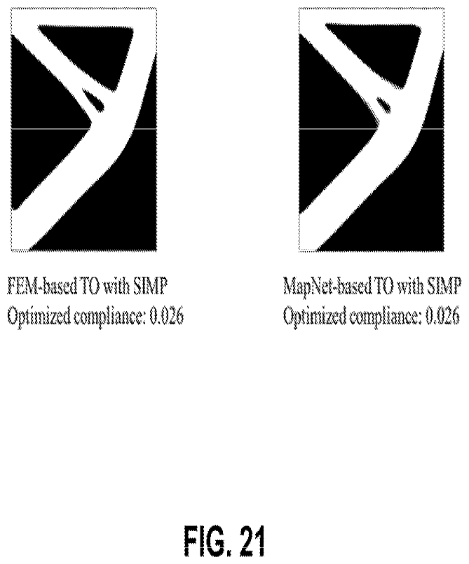

In this section, the disclosed method is implemented in SIMP-based TO process to show that it is not restricted by the type of TO methods. In the SIMP approach, the density field contains intermediate values, and thus a new MapNet is constructed. Following the procedure described in previous sections and again use the cantilever beam design with a single load to generate training data, MapNet is found to be requiring a minimum of 60 training data from the TO process in order to achieve satisfactory prediction accuracy. The performance of MapNet is then evaluated by directly implementing it into the SIMP process and comparing the design solution with that obtained from FEM-based SIMP on this design case. Satisfactory results are obtained as shown in FIG. 21.

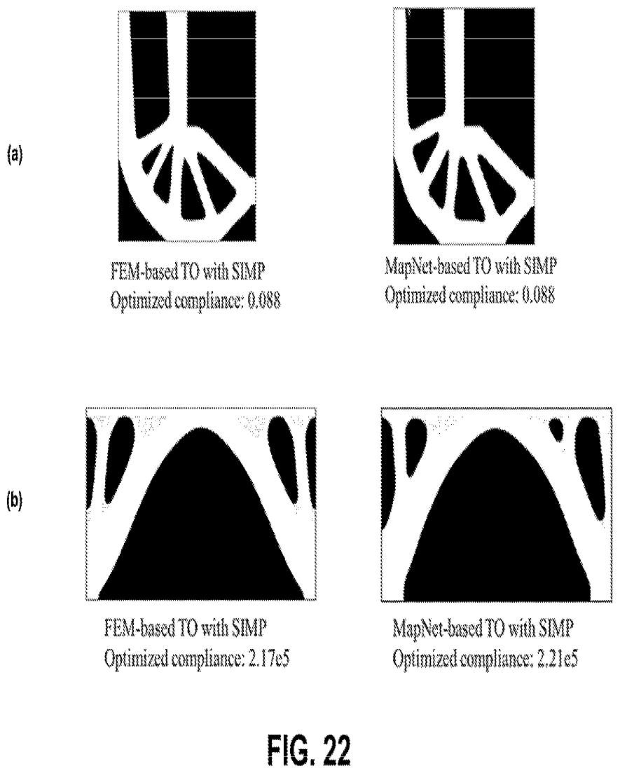

Next for the demonstration of transferability, the MapNet-based SIMP is used directly to design the L-shaped beam and the bridge. The optimized results obtained for each corresponding design problem are compared to the design solutions obtained from the FEM-based SIMP in FIG. 22. These results again illustrate the good transferability of the disclosed method.

C.5. Application to Thermal Problem

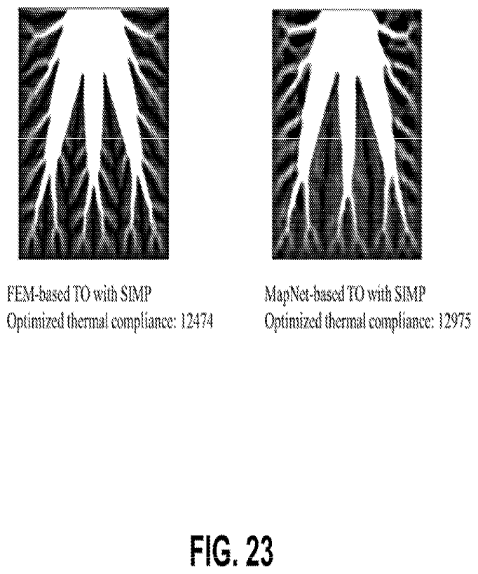

The disclosed method is also applied to design structures with minimum thermal compliance to further demonstrate its performance. The two design problems are described in Section A. The first design problem being considered has a small region of fixed temperature area located at the center of the top boundary (subplot (a) of FIG. 1B). The domain size of the design problem is again selected to be 512×512, with the volume fraction constraint chosen as 0.4. This problem is firstly solved using the FEM-based SIMP, the filter radius is selected to be 16. The process converges around 100 iterations and the optimized results are shown in the left subplot of FIG. 23. A new MapNet with the same architecture as the previous one is constructed and trained using the data obtained from the first few iterations of the FEM-based TO. Specifically, it is found that 40 TO data are sufficient to train MapNet to give a satisfactory performance. The coarse-scale mesh size for this problem is again 32×32. By observing the distribution and range of thermal compliances from the first five iterations of FEM-based TO, the normalization factors for this thermal problem are selected to be 200 and 5 for the coarse and fine-scale thermal compliance respectively. Following the same approach shown in FIG. 3, the trained MapNet is implemented into the TO process and the thermal compliance is minimized using the MapNet-based TO. The optimized results are shown in FIG. 23 and it is observed that the results are close to those from the FEM-based TO.

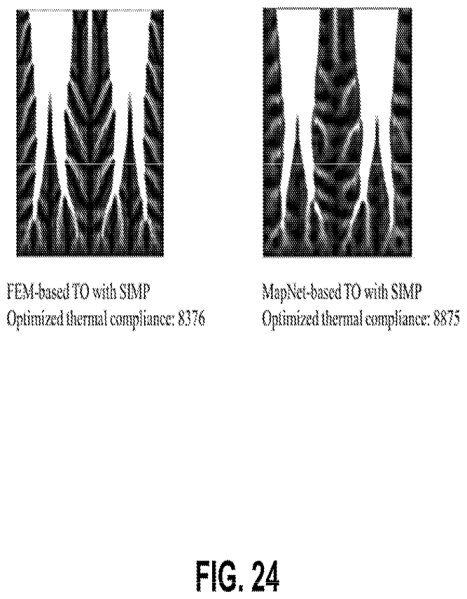

To demonstrate the transferability of the trained MapNet, the thermal design problem with a larger region of fixed temperature located on the top of the boundary (subplot (b) of FIG. 1B) is solved using MapNet trained using the data from the first thermal problem, and design results are presented in FIG. 24 together with those obtained from the FEM-based TO. Although the ground truth optimized result looks very different to the first problem, the similar result produced by the MapNet-based method again indicate the good transferability of the MapNet.

### D. Extension of the Disclosed Method

Although the disclosed method shows a great efficiency in solving design problems in the 2D domain, it can potentially be extended to solve 3D problems. As the computational time requirements involved in 3D simulations are much greater than those in 2D ones, the potential time saving can be massive if a large difference is chosen between the coarse and fine scales.

### E. Details of Embodiments of the Present Invention

Embodiments of the present invention are elaborated as follows based on the details, examples, applications, etc., as disclosed above for the ANN-based model-order-reduction method. Note that from the discussion above, the ANN-based model-order-reduction method can be implemented in a computer system by appropriate programming.

A first aspect of the present invention is to provide a first computer-implemented method for computing a mechanical field of a structure. The mechanical field is related to the design problem considered in TO of the structure. If the design problem is a structural compliance minimization design problem, the mechanical field may be a stress-strain field or a strain energy field. In case the design problem is a thermal compliance minimization design problem, the mechanical field may be selected to be a temperature field.

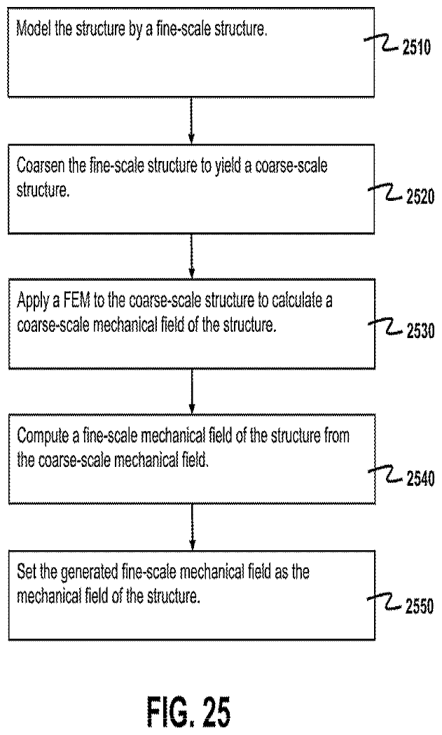

FIG. 25 depicts a flowchart showing exemplary steps of the first computer-implemented method. The first method comprises steps 2510, 2520, 2530, 2540 and 2550.

In the step 2510, a fine-scale structure is prepared or set up for modelling the structure. The fine-scale structure is a geometric model obtained by dividing the structure into a plurality of fine-scale elements such that the structure is composed of the plurality of fine-scale elements.

The fine-scale structure may be represented by listing positional coordinates at which different fine-scale elements are located. Note that a density field, denoted as a fine-scale density field, is computable from the fine-scale structure and vice versa. In this sense, the fine-scale structure and the fine-scale density field are equivalent. The fine-scale structure can be defined by the fine-scale density field, and vice versa. In certain embodiments, the fine-scale structure is the fine-scale density field.

After the fine-scale structure is obtained in the step 2510, the fine-scale structure is coarsened in the step 2520 to generate a coarse-scale structure. In particular, the generated coarse-scale structure is composed of a plurality of coarse-scale elements with a first number of respective coarse-scale elements in the plurality of coarse-scale elements being selected to be less than a second number of respective fine-scale elements in the plurality of fine-scale elements. Detailed procedure of the coarsening process can be found in Section B, and examples thereof can also be found in Section C.

Similar to the fine-scale structure, the coarse-scale structure is also a geometric model obtainable by dividing the structure into the plurality of coarse-scale elements, and may be represented by listing positional coordinates at which different coarse-scale elements are located. A density field, denoted as a coarse-scale density field, is computable from the coarse-scale structure and vice versa. In this sense, the coarse-scale structure and the coarse-scale density field are equivalent. The coarse-scale structure can be defined by the coarse-scale density field, and vice versa. In certain embodiments, the coarse-scale structure is the coarse-scale density field.

In the step 2520, preferably the coarsening of the fine-scale structure to generate the coarse-scale structure is realized by scaling down the fine-scale density field to generate the coarse-scale density field.

After the coarse-scale structure is obtained in the step 2520, a FEM is applied to the coarse-scale structure to calculate a coarse-scale mechanical field of the structure in the step 2530.

In the step 2540, advantageously, a fine-scale mechanical field of the structure is computed from the coarse-scale mechanical field instead of using the FEM to directly compute the fine-scale mechanical field from the fine-scale structure. It enables a reduction in computation cost in obtaining the fine-scale mechanical field. Note that both the coarse-scale structure and the fine-scale structure are geometric models, and the coarse-scale structure has a lower model order than the fine-scale structure. It follows that obtaining the fine-scale mechanical field from the coarse-scale structure instead of from the fine-scale one utilizes model-order reduction to achieve computation-requirement reduction.

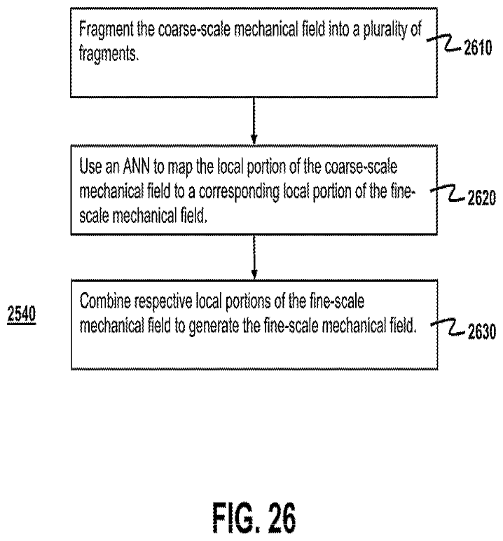

FIG. 26 depicts a flowchart showing exemplary steps in performing the step 2540. Execution of the step 2540 includes execution of steps 2610, 2620 and 2630.

In the step 2610, the coarse-scale mechanical field is fragmented into a plurality of fragments. An individual fragment has a fragment boundary on the coarse-scale mechanical field such that the individual fragment is a local portion of the coarse-scale mechanical field within the fragment boundary. For instance, a non-overlapping fragment 520 in FIG. 5 has a fragment boundary 525, and is a local portion of a field (domain) 590 within the boundary 525. In another example, an overlapping fragment 620 in FIG. 6 has a fragment boundary 625. Detailed procedure of the fragmentation process can be found in Section B, and examples thereof can also be found in Section C. Note that as mentioned in Section B, fragment overlapping among respective fragments in the plurality of fragments may be present or absent.

In the step 2620, an ANN is used to map, or to estimate, the local portion of the coarse-scale mechanical field to a corresponding local portion of the fine-scale mechanical field. The corresponding local portion of the fine-scale mechanical field is a portion of the fine-scale mechanical field within the fragment boundary of the individual fragment. Furthermore, all fragments in the plurality of fragments are processed with this mapping procedure. As a result, respective local portions of the fine-scale mechanical field for the plurality of fragments are computed. Advantageously, the ANN is exemplarily implemented as MapNet. Details of MapNet can be found in Sections B and C. In certain embodiments, the MapNet comprises plural convolutional layers and plural deconvolutional layers. Each of the convolutional and deconvolutional layers has a filter size of 3×3, a stride of 2×2 except for a last layer of the MapNet, and an activation function of RELU. The last layer of the MapNet has a 1×1 stride.

In the step 2630, the respective local portions of the fine-scale mechanical field are combined (defragmented) to generate the fine-scale mechanical field. Particularly, the respective local portions are combined through a defragmentation process as illustrated in Sections B and C. In short, the defragmentation process is done by combining the respective local portions of the fine-scale mechanical field edge-to-edge for the case of non-overlapping fragmentation. For the case of overlapping fragmentation, the defragmentation process is that the fragments are also combined but at each point on an overlapping area on which multiple fragments are overlapped, an average value of the point over the aforesaid multiple fragments is taken.

Refer to FIG. 2. After the fine-scale mechanical field is generated in the step 2540, the generated fine-scale mechanical field is set as the mechanical field of the structure in the step 2550. Thereby, it allows the fine-scale mechanical field with a higher accuracy than the coarse-scale mechanical field to be used as the mechanical field without a need to use the FEM to directly compute the entire fine-scale mechanical field from the fine-scale structure. Computation cost saving is thus resulted.

The mechanical field of the structure as obtained in the step 2550 can be advantageously used in TO of the structure.

A second aspect of the present invention is to provide a second computer-implemented method for performing TO of a structure according to a design requirement. The design requirement is specified as minimizing or maximizing an objective function subjected to one or more constraints. Note that if the objective function and the one or more constraints are related to a structural compliance minimization design problem, the mechanical field may be set to be a strain energy field or a stress-strain field. Similarly, if the objective function and the one or more constraints are related to a thermal compliance minimization design problem, the mechanical field may be set to be a temperature field.

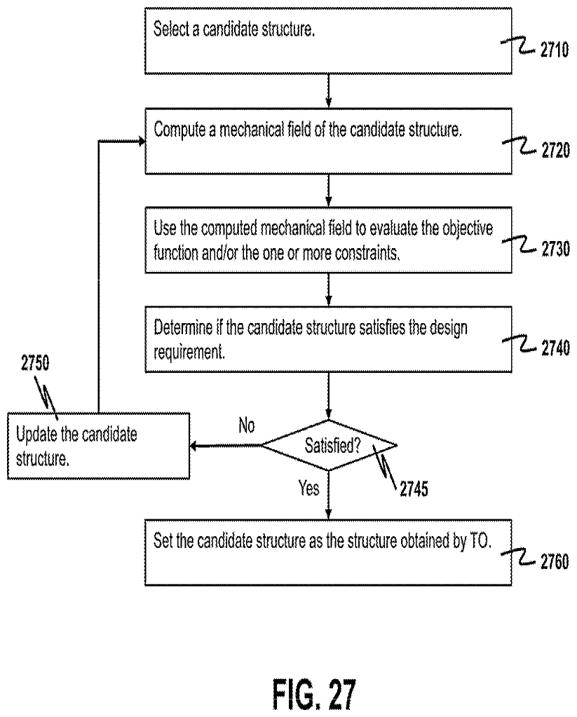

FIG. 27 depicts a flowchart showing exemplary steps of the second computer-implemented method. The second method comprises steps 2710, 2720, 2730, 2740, 2745, 2750 and 2760.

The step 2710 is an initialization step. In the step 2710, a candidate structure for testing whether the candidate structure satisfies the design requirement is selected.

In the step 2720, a mechanical field of the candidate structure is computed according to any of the embodiments of the first computer-implemented method disclosed above.

The computed mechanical field of the candidate structure is used in the step 2730 to evaluate the objective function, the one or more constraints, or both of the objective function and the one or more constraints.

Whether the candidate structure satisfies the design requirement is determined in the step 2740 according to the objective function and the one or more constraints as evaluated.

If it is determined that the candidate structure does not satisfy the design requirements (the decision-making step 2745), the candidate structure is updated in the step 2750, and the steps 2720, 2730, 2740 and 2745 are repeated to process the updated candidate structure.

If it is determined that the candidate structure satisfies the design requirements (the decision-making step 2745), the candidate structure that satisfies the design requirement is set in the step 2760 as the structure obtained by TO,

As mentioned above, the first and second methods are realizable by a computer system. The computer system is implemented with one or more computers. An individual computer may be a general-purpose computer, a workstation, a computing server, a distributed server in a computing cloud, a notebook computer, a mobile computing device, etc.

The present disclosure may be embodied in other specific forms without departing from the spirit or essential characteristics thereof. The present embodiment is therefore to be considered in all respects as illustrative and not restrictive. The scope of the invention is indicated by the appended claims rather than by the foregoing description, and all changes that come within the meaning and range of equivalency of the claims are therefore intended to be embraced therein.

### REFERENCES

There follows a list of references that are occasionally cited in the specification. Each of the disclosures of these references is incorporated by reference herein in its entirety.
T. GOEL and W. J. ROUX (2010), “Topology optimization for designing engineering product,” US Patent Application Publication No. 2010/0262406.
Y. LUO, Z. KANG and P. LIU (2021), “Structural topology optimization method based on material-field reduction series expansion,” US Patent Application Publication No. 2021/073428.
M. RAISSI, P. PERDIKARIS and G. E. KARNIADAKIS (2021), “Physics informed learning machine,” U.S. Pat. No. 10,963,540.
M. Y. WANG (2021), “Methods of high-definition cellular level set in B-splines for modeling and topology optimization of three-dimensional cellular structures,” U.S. Pat. No. 10,984,593.
G. C. ATES and R. M. GORGULUARSLAN (2021). Two-stage convolutional encoder-decoder network to improve the performance and reliability of deep learning models for topology optimization. Structural and Multidisciplinary Optimization. 63(4), 1927-1950.
M. P. BENDSOE and O. SIGMUND (2003). Topology optimization: theory, methods, and applications. Springer Science & Business Media.
H. CHI, Y. ZHANG, T. L. E. TANG, L. MIRABELLA, L. DALLORO, L. SONG and G. H. PAULINO (2021). Universal machine learning for topology optimization. Computer Methods in Applied Mechanics and Engineering. 375, 112739.
H. T. KOLLMANN, D. W. ABUEIDDA, S. KORIC, E. GULERYUZ and N. A. SOBH (2020). Deep learning for topology optimization of 2D metamaterials. Materials Design. 196, 109098.
S. LEE, H. KIM, Q. X. LIEU and J. LEE (2020). CNN-based image recognition for topology optimization. Knowledge-Based System. 198, 105887.
C. QIAN and W. YE (2021). Accelerating gradient-based topology optimization design with dual-model artificial neural networks. Structural and Multidisciplinary Optimization. 63(4), 1687-1707.
X. QU, N. PAGALDIPTI, R. FLEURY and J. SAIKI (2016). Thermal topology optimization in optistruct software. In 17th AIAA/ISSMO Multidisciplinary analysis and optimization conference (p. 3829).
R. K. TAN, C. QIAN, M. WANG and W. YE (2022). An efficient data generation method for ANN-based surrogate models. Structural and Multidisciplinary Optimization. 63(3), pp 1-22.
D. WANG, C. XIANG, Y. PAN, A. CHEN, X. ZHOU and Y. ZHANG (2021). A deep convolutional neural network for topology optimization with perceptible generalization ability. Engineering Optimization. 1-16.
D. A. WHITE, W. ARRIGHI, J. J. KUDO and S. E. WATTS (2019). Multiscale topology optimization using neural network surrogate models. Computer Methods in Applied Mechanics and Engineering. 346, 1118-1135.
Y. YU, T. HUR, J. JUNG and L. G. JANG (2019). Deep learning for determining a near-optimal topological design without any iteration. Structural and Multidisciplinary Optimization. 59(3), pp. 787-799.

What is claimed is:

1. A computer-implemented method for computing a mechanical field of a structure, the method comprising:
modelling the structure by a fine-scale structure, wherein the fine-scale structure is obtained by dividing the structure into a plurality of fine-scale elements;
coarsening the fine-scale structure to yield a coarse-scale structure such that the coarse-scale structure is composed of a plurality of coarse-scale elements wherein a first number of respective coarse-scale elements in the plurality of coarse-scale elements is less than a second number of respective fine-scale elements in the plurality of fine-scale elements;
applying a finite element method (FEM) to the coarse-scale structure to calculate a coarse-scale mechanical field of the structure;
computing a fine-scale mechanical field of the structure from the coarse-scale mechanical field, wherein the computing of the fine-scale mechanical field from the coarse-scale mechanical field comprises:
fragmenting the coarse-scale mechanical field into a plurality of fragments, whereby an individual fragment has a fragment boundary on the coarse-scale mechanical field such that the individual fragment is a local portion of the coarse-scale mechanical field within the fragment boundary;
using an artificial neural network (ANN) to map the local portion of the coarse-scale mechanical field to a corresponding local portion of the fine-scale mechanical field, whereby respective local portions of the fine-scale mechanical field for the plurality of fragments are computed; and
combining the respective local portions of the fine-scale mechanical field to generate the fine-scale mechanical field;
and
setting the generated fine-scale mechanical field as the mechanical field of the structure, thereby allowing the fine-scale mechanical field with a higher accuracy than the coarse-scale mechanical field to be used as the mechanical field without a need to use the FEM to directly compute the entire fine-scale mechanical field from the fine-scale structure for computation cost saving.

2. The method of claim 1, wherein the ANN is implemented as MapNet.

3. The method of claim 2, wherein the MapNet comprises plural convolutional layers, plural deconvolutional layers and a residual block, wherein each of the convolutional and deconvolutional layers has a filter size of 3×3, a stride of 2×2 except for a last layer of the MapNet, and an activation function of RELU, wherein the last layer of the MapNet has a 1×1 stride, wherein inputs of the MapNet are the local portion of the coarse-scale mechanical field, and a corresponding local portion of a fine-scale density field within the fragment boundary, the fine-scale density field being defined by the fine-scale structure, and wherein at each deconvolutional layer, a density field with the same scale downsampled from the fine-scale density field is added.

4. The method of claim 1, wherein in mapping the local portion of the coarse-scale mechanical field to the corresponding local portion of the fine-scale mechanical field, the ANN predicts the corresponding local portion of the fine-scale mechanical field according to a fine-scale density field and the local portion of the coarse-scale mechanical field, wherein the fine-scale structure defines the fine-scale density field.

5. The method of claim 1, wherein in coarsening the fine-scale structure to yield the coarse-scale structure, the coarse-scale structure is obtained by scaling down a fine-scale density field to give a coarse-scale density field, wherein the fine-scale structure defines the fine-scale density field, and wherein the coarse-scale density field defines the coarse-scale structure.

6. The method of claim 1, wherein in fragmenting the coarse-scale mechanical field into the plurality of fragments, fragment overlapping among respective fragments in the plurality of fragments is present.

7. The method of claim 1, wherein in fragmenting the coarse-scale field into the plurality of fragments, fragment overlapping among respective fragments in the plurality of fragments is absent.

8. A computer-implemented method for performing topology optimization (TO) of a structure according to a design requirement, the design requirement being specified as minimizing or maximizing an objective function subjected to one or more constraints, the method comprising the steps of:
(a) selecting a candidate structure for testing whether the candidate structure satisfies the design requirement;
(b) computing a mechanical field of the candidate structure according to the method of claim 1;
(c) using the computed mechanical field to evaluate the objective function, the one or more constraints, or both of the objective function and the one or more constraints;
(d) determining whether the candidate structure satisfies the design requirement; and
(e) if the candidate structure does not satisfy the design requirement, updating the candidate structure and repeating the steps (b)-(e), otherwise setting the candidate structure that satisfies the design requirement as the structure obtained by TO.

9. The method of claim 8, wherein the objective function and the one or more constraints are related to a structural compliance minimization design problem, and wherein the mechanical field is a strain energy field.

10. The method of claim 8, wherein the objective function and the one or more constraints are related to a thermal compliance minimization design problem, and wherein the mechanical field is a temperature field.

11. A computer-implemented method for performing topology optimization (TO) of a structure according to a design requirement, the design requirement being specified as minimizing or maximizing an objective function subjected to one or more constraints, the method comprising the steps of:
(a) selecting a candidate structure for testing whether the candidate structure satisfies the design requirement;
(b) computing a mechanical field of the candidate structure according to the method of claim 2;
(c) using the computed mechanical field to evaluate the objective function, the one or more constraints, or both of the objective function and the one or more constraints;
(d) determining whether the candidate structure satisfies the design requirement; and
(e) if the candidate structure does not satisfy the design requirement, updating the candidate structure and repeating the steps (b)-(e), otherwise setting the candidate structure that satisfies the design requirement as the structure obtained by TO.

12. A computer-implemented method for performing topology optimization (TO) of a structure according to a design requirement, the design requirement being specified as minimizing or maximizing an objective function subjected to one or more constraints, the method comprising the steps of:
(a) selecting a candidate structure for testing whether the candidate structure satisfies the design requirement;
(b) computing a mechanical field of the candidate structure according to the method of claim 3;
(c) using the computed mechanical field to evaluate the objective function, the one or more constraints, or both of the objective function and the one or more constraints;
(d) determining whether the candidate structure satisfies the design requirement; and
(e) if the candidate structure does not satisfy the design requirement, updating the candidate structure and repeating the steps (b)-(e), otherwise setting the candidate structure that satisfies the design requirement as the structure obtained by TO.

13. A computer-implemented method for performing topology optimization (TO) of a structure according to a design requirement, the design requirement being specified as minimizing or maximizing an objective function subjected to one or more constraints, the method comprising the steps of:
(a) selecting a candidate structure for testing whether the candidate structure satisfies the design requirement;
(b) computing a mechanical field of the candidate structure according to the method of claim 4;
(c) using the computed mechanical field to evaluate the objective function, the one or more constraints, or both of the objective function and the one or more constraints;
(d) determining whether the candidate structure satisfies the design requirement; and
(e) if the candidate structure does not satisfy the design requirement, updating the candidate structure and repeating the steps (b)-(e), otherwise setting the candidate structure that satisfies the design requirement as the structure obtained by TO.

14. A computer-implemented method for performing topology optimization (TO) of a structure according to a design requirement, the design requirement being specified as minimizing or maximizing an objective function subjected to one or more constraints, the method comprising the steps of:
(a) selecting a candidate structure for testing whether the candidate structure satisfies the design requirement;
(b) computing a mechanical field of the candidate structure according to the method of claim 5;
(c) using the computed mechanical field to evaluate the objective function, the one or more constraints, or both of the objective function and the one or more constraints;
(d) determining whether the candidate structure satisfies the design requirement; and
(e) if the candidate structure does not satisfy the design requirement, updating the candidate structure and repeating the steps (b)-(e), otherwise setting the candidate structure that satisfies the design requirement as the structure obtained by TO.

15. A computer-implemented method for performing topology optimization (TO) of a structure according to a design requirement, the design requirement being specified as minimizing or maximizing an objective function subjected to one or more constraints, the method comprising the steps of:
(a) selecting a candidate structure for testing whether the candidate structure satisfies the design requirement;
(b) computing a mechanical field of the candidate structure according to the method of claim 6;
(c) using the computed mechanical field to evaluate the objective function, the one or more constraints, or both of the objective function and the one or more constraints;
(d) determining whether the candidate structure satisfies the design requirement; and
(e) if the candidate structure does not satisfy the design requirement, updating the candidate structure and repeating the steps (b)-(e), otherwise setting the candidate structure that satisfies the design requirement as the structure obtained by TO.

16. A computer-implemented method for performing topology optimization (TO) of a structure according to a design requirement, the design requirement being specified as minimizing or maximizing an objective function subjected to one or more constraints, the method comprising the steps of:
(a) selecting a candidate structure for testing whether the candidate structure satisfies the design requirement;
(b) computing a mechanical field of the candidate structure according to the method of claim 7;
(c) using the computed mechanical field to evaluate the objective function, the one or more constraints, or both of the objective function and the one or more constraints;
(d) determining whether the candidate structure satisfies the design requirement; and
(e) if the candidate structure does not satisfy the design requirement, updating the candidate structure and repeating the steps (b)-(e), otherwise setting the candidate structure that satisfies the design requirement as the structure obtained by TO.
